(19) United States
(12) Patent Application Publication
(10) Pub. No.: US 2026/0068019 A1
(43) Pub. Date: Mar. 5, 2026

(54) Anti-Electrostatic Earthing Textile

(71) Applicant: Guangzhou JieDiBao Health Technology Co., Ltd., Guangzhou City (CN)

(72) Inventor: Yulin Shi, Foshan City (CN)

(73) Assignee: Guangzhou JieDiBao Health Technology Co., Ltd., Guangzhou City (CN)

(21) Appl. No.: 19/280,482

(22) Filed: Jul. 25, 2025

(30) Foreign Application Priority Data
Aug. 29, 2024 (CN) 202411201249.9

(51) Int. Cl. H05F 3/02; D03D 15/533

(52) U.S. Cl. CPC H05F 3/02; D03D 15/533; D10B 2401/18

(57) ABSTRACT

The invention discloses an anti-electrostatic earthing textile, comprising: cloth and an electrostatic discharger; The cloth comprises insulating yarn and conductive yarn, wherein the conductive yarn is woven into the insulating yarn; The electrostatic discharger comprises a leading electrode, an adjustment module, and a discharge electrode, wherein the adjustment module is electrically connected between the leading electrode and the discharge electrode; The leading electrode is connected to the conductive yarn of the cloth, and the discharge electrode is connected to the earth. The cloth leads static electricity to the earth through the electrostatic discharger, thereby allowing the user to maintain bioelectric balance during use.

### REFERENCE TO PRIOR APPLICATION

This application claims priority to Chinese Patent Application 202411201249.9, filed on Aug. 29, 2024, which is incorporated herein by reference.

### TECHNICAL FIELD

The invention relates to the field of earthing, and more particularly, to an antistatic earthing textile.

### BACKGROUND

Static electricity is generated during the process of contact and separation of two different materials, such as through friction, induction, or direct charge transfer. In dry environments, people are more prone to generate and accumulate static electricity when sleeping, as their hair comes into contact with textiles. Static electricity can interfere with the body's bioelectric balance and cause discomfort to the nervous system, such as dizziness, headache, insomnia, and irritability. Therefore, it is important to reduce the impact of static electricity on the body's electrical balance.

At present, many types of textiles capable of eliminating static electricity are available on the market. Typically, the cloth is connected to a metal wire, and the other end of the metal wire is connected to the earth, allowing current to be directly discharged through the metal wire. This method cannot effectively maintain the internal electrical balance of the human body, as different individuals have varying levels of sensitivity to electricity. When the charge in the human body accumulates to a certain level and discharges, direct discharge may cause discomfort or even pain in some individuals. In some cases, when abnormal current appears at the earthing terminal, the current may also flow back along the metal wire to the textile and come into contact with the human body, thereby affecting the bioelectric balance. In severe cases, this may even cause electric shock, further affecting the bioelectric balance of the human body. Therefore, the method of directly connecting textiles to the earth via wires cannot meet the requirement of maintaining human bioelectric balance when a person is connected to the earth.

### SUMMARY

To address the aforementioned issues, it is an objective of the invention to provide an anti-electrostatic earthing textile, realized through the following technical solutions:

An embodiment of the invention provides an anti-electrostatic earthing textile comprising: a cloth and an electrostatic discharger,

The cloth comprises insulating yarns and conductive yarns, which are woven together to form the cloth;

The electrostatic discharger comprises a leading electrode, an adjustment module, and a discharge electrode, where the adjustment module is electrically connected between the leading electrode and the discharge electrode. The leading electrode is connected to the conductive yarn of the cloth, and the discharge electrode is connected to the earth.

The adjustment module includes a slide rheostat and an intelligent load device. The slide rheostat is equipped with terminal A, terminal B, and terminal P. The intelligent load device is connected between terminals A and B of the slide rheostat. Terminal B of the slide rheostat is also connected to the discharge electrode, while terminal P is connected to the leading electrode.

Wherein, the conductive yarns are uniformly arranged on the cloth to promptly absorb static electricity generated within, conducting it via the leading electrode to the static discharger. When the static voltage is below the operational voltage of the intelligent load device in the discharger, the device acts as a load, enabling current flow from the leading electrode to the earth electrode for static electricity extraction. Upon the static voltage reaching the device's working voltage, the intelligent load device works with the slide rheostat to adjust the output current, ensuring a stable discharge.

Preferably, the conductive yarn is manufactured by applying a layer of conductive material on the exterior of the insulating yarn, where the conductive material constitutes 16%-20% of the conductive yarn's weight, and the conductive yarn accounts for 3%-10% of the cloth's total weight.

Preferably, the conductive yarns are uniformly woven in a crosswise and lengthwise pattern on the insulating yarns.

Preferably, a fuse is installed between terminal B of the slide rheostat and the discharge electrode;

The fuse is a self-resetting fuse. When the current flowing through the fuse is excessive, the fuse automatically disconnects. When the temperature returns to ambient, the fuse automatically resets and restores the circuit.

Preferably, the cloth is equipped with a connecting portion.

Preferably, the connecting portion is a snap fastener, with the female snap arranged on the conductive yarn of the cloth and the male snap connected to the leading electrode of the electrostatic discharger.

Preferably, the connecting portion is made of conductive metal material.

Preferably, the intelligent load device comprises multiple singlechips, specifically a 1st, 2nd, and 3rd singlechip.

Preferably, the singlechips are interconnected via pin-to-pin connections;

Wherein, the 2nd pin of the 1st singlechip is connected to the 1st pin of the 2nd singlechip; the 6th pin of the 1st singlechip is connected to terminal A of the slide potentiometer; the 7th pin of the 1st singlechip is parallel connected to the 7th pin of the 2nd singlechip, the 7th pin of the 3rd singlechip, and terminal B of the slide rheostat; the 8th pin of the 1st singlechip is connected to terminal A of the slide potentiometer; and the 5th pin of the 1st singlechip is connected to the 8th pin of the 2nd singlechip.

The 2nd pin of the 2nd singlechip is connected to the 1st pin of the 3rd singlechip, the 4th pin of the 2nd singlechip is connected to the 2nd pin of the 3rd singlechip, the 5th pin of the 2nd singlechip is connected to the 8th pin of the 3rd singlechip, and the 7th pin of the 2nd singlechip is connected to the 7th pin of the 3rd singlechip.

The 3rd pin of the 3rd singlechip is connected to the 4th pin of the 3rd singlechip, and the 5th pin of the 3rd singlechip is connected to terminal B of the slide rheostat.

Preferably, the intelligent load device is equipped with a plurality of resistors, including a 1st resistor R1, a 2nd resistor R2, a 3rd resistor R3, and a 4th resistor R4. The 1st resistor R1 is installed between terminal B of the slide rheostat and the intelligent load device, while the 2nd resistor R2, the 3rd resistor R3, and the 4th resistor R4 are integrated into the intelligent load device.

Wherein, the 1st resistor R1 is connected in series between terminal B of the slide rheostat and the 5th pin of the 3rd singlechip, the 2nd resistor R2 is connected in series between the 3rd pin and the 4th pin of the 3rd singlechip, the 3rd resistor R3 is installed between terminal A of the slide rheostat and the 8th pin of the 1st singlechip, and the 4th resistor R4 is installed between terminal A of the slide rheostat and the 6th pin of the 1st singlechip.

Compared to the prior art, the advantageous effects of the invention are as follows:

The anti-electrostatic earthing textile provided in this application includes a cloth and an electrostatic discharger. The cloth is composed of insulating yarn and conductive yarn. The conductive yarn is evenly interwoven within the insulating yarn to provide the maximum area for current leading, effectively dissipating static electricity generated during the friction of the cloth. The cloth is connected to the leading electrode of the electrostatic discharger through a conductive wire, allowing current to be transferred from the cloth to the electrostatic discharger. The leading electrode acts as the initial current receiving point for the electrostatic discharger, directing the current through the adjustment module, and subsequently through the discharge electrode, ultimately channeling the current safely to the earth to complete its discharge.

Users can adjust the resistance of the slide rheostat to adjust the magnitude and duration of electrostatic discharge, thereby adapting to the inductive balance of the human body. Furthermore, in environments with minimal static electricity generation, the resistance of the slide rheostat is adjusted to its maximum to prevent current backflow. Secondly, when static electricity is readily generated in the environment, the slide rheostat's resistance is adjusted to an optimal position—corresponding to the body's electrical balance—allowing smooth discharge of static electricity to the earth.

When the static voltage is insufficient to power the intelligent load device, it remains inactive and consumes current as a load. Current directly passes through the slide rheostat and is subsequently conducted to the earth via aearthing metal connector. Secondly, when the electrostatic voltage is excessively high, current activates the intelligent load device. By adjusting the slide rheostat, the discharge magnitude and duration are modified to suit the user's current perception threshold, ensuring smooth discharge of static electricity to the earth and maintaining the user's bioelectric equilibrium.

### BRIEF DESCRIPTION OF DRAWINGS

To more clearly illustrate the detailed description of the preferred embodiments of the invention or the technical solutions in the prior art, a brief introduction of the embodiment drawings required for the detailed description of the preferred embodiments or description of the prior art is provided below.

In all drawings, similar elements or parts are generally identified by similar reference numerals. In the drawings, each element or part is not necessarily drawn to scale.

FIG. 1 is a schematic diagram showing the assembly of an anti-electrostatic earthing textile according to the invention;

FIG. 2 is a schematic diagram illustrating the assembly of an intelligent load device according to the invention;

FIG. 3 is a circuit diagram of an intelligent load device according to the invention;

### DESCRIPTION OF MARKINGS IN THE DRAWINGS

1—cloth, 11—conductive yarn, 2—electrostatic discharger, 31—female snap, 32—male snap;
21—leading electrode, 22—discharge electrode, 23—adjustment module, R1—1st resistor, R2—2nd resistor, R3—3rd resistor, R4—4th resistor, R5—slide rheostat, F1—fuse, U1—1st singlechip, U2—2nd singlechip, U3—3rd singlechip.

### DETAILED DESCRIPTION OF EMBODIMENTS

To more clearly understand the aforementioned objectives, features, and advantages of the invention, a detailed description of the invention is provided below in conjunction with the drawings and detailed description of the preferred embodiments.

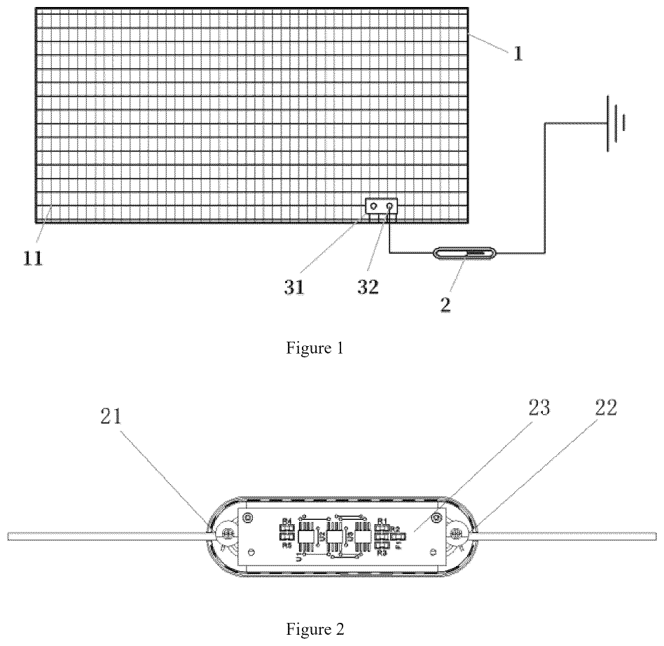

The preferred embodiments of the invention are described below with reference to the drawings. It should be understood that the preferred embodiments described herein are merely for illustrating and explaining the invention and are not intended to limit the specific embodiments of the invention. Referring to FIGS. 1 to 3, they illustrate the preferred structures of an anti-electrostatic earthing textile according to the invention.

As shown in FIGS. 1 to 3, an anti-electrostatic earthing textile provided in an embodiment of the invention comprises: a cloth 1 and an electrostatic discharger 2.

Specifically, cloth 1 includes insulating yarn and conductive yarn 11. The conductive yarn 11 is crisscrossed and uniformly woven within the insulating yarn. The electrostatic discharger 2 comprises a leading electrode 21, an adjustment module 23, and a discharge electrode 22. The adjustment module 23 is electrically connected between the leading electrode 21 and the discharge electrode 22. The leading electrode 21 is connected to the conductive yarn 11 of cloth 1, and the discharge electrode 22 is earthed. The adjustment module 23 includes a slide rheostat R5 and an intelligent load device. The slide rheostat R5 has terminal A, terminal B, and terminal P; the leading electrode 21 is positioned on terminal P of the slide rheostat R5. Terminals A and B of the slide rheostat R5 are connected to the intelligent load device, while terminal B is also connected to the discharge electrode 22. The leading electrode 21 is connected to terminal P of the slide rheostat R5.

An embodiment of the 1st aspect of the invention provides an anti-electrostatic earthing textile. When friction between hair and cloth 1 generates static electricity, it passes through the conductive yarn 11 in cloth 1 and enters the earthed electrostatic discharger 2 via the leading electrode 21. The current is managed by the intelligent load device, which actively and intelligently controls the resistance value in conjunction with the slide rheostat R5, altering the discharge magnitude and duration to suit the perception threshold of different individuals. This threshold is the minimal current capable of eliciting a slight sensation in the human body. The static electricity is then connected to the earth via the discharge electrode 22, restoring electrical balance to the human body.

Wherein, in environments where static electricity is less likely to occur, the resistance of the slide rheostat R5 can be adjusted to its maximum to prevent current backflow. Conversely, when static electricity is easily generated, the resistance of the slide rheostat R5 can be adjusted to an adaptive position, that is, the electrical balance position for the human body, allowing static electricity to be smoothly discharged to the earth. Furthermore, when a large current occurs at the leading electrode 21, to prevent instantaneous current discharge causing noticeable electric shock pain, the intelligent load device activates and works together with the slide rheostat R5 to consume the current, adjust the discharge magnitude and duration, adapt to the user's current perception threshold, and collectively maintain the user's bioelectric equilibrium.

Optionally, as illustrated in FIG. 1, the insulating yarn is natural cotton yarn, chemical fiber yarn, or a blend of pure cotton and chemical fiber yarn. The conductive yarn 11 is fabricated by spraying a layer of conductive material on the surface of the insulating yarn.

In the above embodiments, the insulating yarn is 100% natural, unbleached, and undyed cotton yarn, chemical fiber yarn, or a blend of pure cotton and chemical fiber yarn. Their quality and strength ensure the cloth's durability and tensile resistance. These characteristics make the final cloth 1 product softer and more comfortable while maintaining excellent breathability and moisture absorption.

Wherein, cloth 1 comprises insulating yarn and conductive yarn 11. The conductive yarn 11 is uniformly woven in a crisscross pattern within the insulating yarn. The conductive yarn 11 is clothated by spraying a layer of conductive material on the surface of the insulating yarn. The conductive material accounts for 16%-20% of the conductive yarn's weight; in this embodiment, it is 18%. Values of 16%, 17%, 19%, or 20% are within the scope of this invention. The conductive yarn accounts for 3%-10% of the cloth's weight; in this embodiment, it is 7%. However, percentages of 3%, 4%, 5%, 6%, 8%, 9%, and 10% are also within the scope of this invention. The conductive yarns are crisscrossed and woven into the insulating yarns to maximize contact with generated static electricity, enabling prompt conduction to the static discharger. When the conductive yarn exceeds 10%, the product cost increases, which is unfavorable for pricing; when below 3%, the conductive performance significantly decreases. The cloth can be used to manufacture various bedding products, such as duvet covers, quilts, and sheets.

In another embodiment, metal wires or carbon nanotubes with higher conductivity are mixed with insulating yarns to further enhance the conductivity and electrostatic discharge efficiency of cloth 1. Additionally, the content ratio of the conductive yarn 11 can be adjusted, or different weaving techniques can be employed to accommodate various application scenarios and requirements. These technical solutions remain consistent with the design concept and purpose of the invention, and thus are within its protection scope.

In some embodiments of the invention, as shown in FIGS. 1 to 2, a connecting portion is arranged on cloth 1.

In the above embodiment, a connecting portion is arranged on cloth 1, connected to the leading electrode 21 of the electrostatic discharger 2. The connecting portion enables cloth 1 to cooperate with the electrostatic discharger 2, thereby leading current from cloth 1 to the discharger 2 and achieving electrostatic discharge.

It should be understood that cloth 1 may not include a connecting portion; alternatively, connection can be achieved by other means, such as directly winding the wire from the leading electrode 21 into the conductive yarn 11 of cloth 1.

Optionally, as shown in FIGS. 1 to 2, the connecting portion is a snap fastener 31, with female snap 31 arranged on the conductive yarn 11 of cloth 1, and the male snap 32 connected to the leading electrode 21 of the electrostatic discharger 2.

In the above embodiment, the connecting portion is a snap fastener 31, with female snap 31 arranged on the conductive yarn 11 of cloth 1, and the male snap 32 connected to the leading electrode 21 of the electrostatic discharger 2. The snap fastener 31 design of the connecting portion provides a simple and effective connection method, ensuring efficient static discharge. The female snap 31 of the connecting portion is directly installed on the conductive yarn 11 of cloth 1, ensuring a robust electrical connection, while the connection of male snap 32 with leading electrode 21 of electrostatic discharger 2 ensures efficient static electricity conduction.

It is understood that the connecting portion may employ a magnetic attraction method, utilizing the magnet's pull to achieve quick and firm connectivity. In this design, the female snap 31 could be made of a conductive magnetic material, and the male snap 32 is a magnetic component connected to the leading electrode 21 of the electrostatic discharger 2. The connecting portion can also be designed using zippers or snap rings, which similarly facilitate electrical connection between the conductive yarn 11 and the electrostatic discharger 2. These technical solutions can achieve the objectives of the invention without deviating from its design concept and purpose.

Optionally, as illustrated in FIGS. 1 to 2, the connecting portion is composed of a conductive metal material.

In the abovementioned embodiment, the connecting portion is composed of a conductive metal material. The application of conductive metal materials not only guarantees efficient static electricity conduction but also enhances the durability and stability of the connecting portion. Metal materials such as copper, aluminum, or stainless steel can be chosen for their excellent conductivity, which makes them widely used in electrical connection devices.

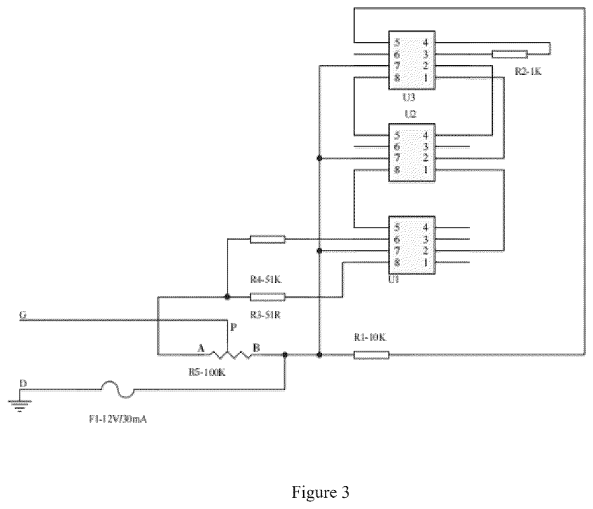

Optionally, as depicted in FIGS. 2 to 3, the fuse F1 is a resettable fuse.

In the aforementioned embodiment, the fuse F1 is a resettable fuse capable of automatically disconnecting the circuit upon detection of abnormal current flow, thus preventing current backflow. A resettable fuse serves as an overcurrent protection device, automatically disconnecting the circuit when abnormal currents cause the fuse temperature to rise excessively; the fuse restores the connection once its temperature returns to ambient levels.

Wherein, when current backflows, such as in reverse flow from the discharge electrode 22, and exceeds the melting threshold of fuse F1, the resettable fuse will automatically disconnect, acting as a circuit breaker to prevent further backflow and thereby maintain the electrical balance within the human body.

It is understood that the resettable fuse is a preferred component within this technical solution. Similarly, although a one-time fuse needs replacement after a single use, it also serves to prevent current backflow and thus falls within the protective scope of this invention.

Optionally, as demonstrated in FIGS. 2 to 3, the intelligent load device encompasses multiple singlechips, including the 1st singlechip U1, the 2nd singlechip U2, and the 3rd singlechip U3, with a pin-to-pin connection between the singlechips.

Wherein, the 2nd pin of the 1st singlechip U1 is connected to the 1st pin of the 2nd singlechip U2; the 6th pin of U1 is connected to terminal A of the slide potentiometer R5; the 7th pin of U1 is in parallel with the 7th pins of U2 and U3, and terminal B of R5; the 8th pin of U1 is connected to terminal A of the slide potentiometer R5; the 5th pin of U1 is connected to the 8th pin of U2.

The 2nd pin of the 2nd singlechip U2 connects to the 1st pin of the 3rd singlechip U3; the 4th pin of U2 connects to the 2nd pin of U3; the 5th pin of U2 connects to the 8th pin of U3; the 5th pin of U2 again connects to the 8th pin of U3; the 7th pin of U2 connects to the 7th pin of U3.

The 3rd pin of the 3rd singlechip U3 is connected to the 4th pin of the 3rd singlechip U3, and the 5th pin of the 3rd singlechip U3 is connected to terminal B of the slide rheostat R5.

It is understood that the number of singlechips can be one, two, three, or more than three and is not limited to the described quantity. Similarly, the pin connections between the singlechips are not limited to the above-mentioned configurations. Any technical solution capable of monitoring abnormal current and adjusting the slide rheostat R5 remains within the design concept and purpose of the invention and thus falls within its scope of protection.

Optionally, as shown in FIGS. 2 to 3, the intelligent load device is provided with a plurality of resistors.

In the above embodiment, multiple resistors are arranged in the intelligent load device, including a 1st resistor R1, a 2nd resistor R2, a 3rd resistor R3, and a 4th resistor R4. The 1st resistor R1 is installed between terminal B of the slide rheostat R5 and the intelligent load device, while the 2nd resistor R2, 3rd resistor R3, and 4th resistor R4 are connected inside the intelligent load device.

Wherein, the 1st resistor R1 is connected in series between terminal B of the slide rheostat R5 and the 5th pin of the 3rd singlechip U3. The 2nd resistor R2 is connected in series between the 3rd and 4th pins of the 3rd singlechip U3. The 3rd resistor R3 is arranged between terminal A of the slide rheostat R5 and the 8th pin of the 1st singlechip U1, and the 4th resistor R4 is arranged between terminal A of the slide rheostat R5 and the 6th pin of the 1st singlechip U1.

It should be understood that this embodiment is not limited to the aforementioned four resistors. The resistor group described here is merely a preferred design for limiting current in the design. Similarly, the number of resistor groups can be one, two, three, or more than three. As long as the configuration enables stable current adjustment and discharge, such technical solutions remain within the design concept and purpose of the invention and thus fall within its scope of protection.

The above description is merely an exemplary embodiment of the invention and does not impose any form of limitation on the invention. Therefore, any modifications, equivalent variations, or improvements made to the above embodiments based on the technical essence of the invention shall still fall within the scope of the technical solutions of the invention.

What is claimed is:

1. An anti-electrostatic earthing textile, characterized by comprising: cloth and an electrostatic discharger,
The cloth comprises insulating yarn and conductive yarn, wherein the conductive yarn and the insulating yarn are woven to form the cloth;
The electrostatic discharger comprises a leading electrode, an adjustment module, and a discharge electrode, wherein the adjustment module is electrically connected between the leading electrode and the discharge electrode; the leading electrode is connected to the conductive yarn of the cloth, and the discharge electrode is connected to the earth;
The adjustment module comprises a slide rheostat and an intelligent load device, wherein the slide rheostat is equipped with terminal A, terminal B, and terminal P;
The intelligent load device is connected to terminal A and terminal B of the slide rheostat; Terminal B of the slide rheostat is also connected to the discharge electrode, and terminal P is connected to the leading electrode;
Wherein, the conductive yarns of the cloth are uniformly arranged on the cloth to promptly absorb static electricity generated within the cloth and conduct it to an electrostatic discharger via the leading electrode; When the static voltage is below the operating voltage of the intelligent load device in the electrostatic discharger, the device functions as a load, allowing current to flow from the leading electrode to the earthing electrode, thereby achieving static electricity discharge; Upon reaching the operating voltage, the intelligent load device coordinates with the slide rheostat to adjust the static electricity output current, ensuring stable output of static electricity.

2. The antistatic earthing textile according to claim 1, characterized in that:
The conductive yarn is formed by spraying a layer of conductive material onto the exterior of insulating yarns, with the conductive material comprising 16%-20% of the conductive yarn's total weight; The conductive yarn constitutes 3%-10% of the overall weight of the cloth.

3. The antistatic earthing textile according to claim 2, characterized in that:
The conductive yarns are uniformly arranged on the insulating yarns in an interwoven vertical and horizontal manner.

4. The antistatic earthing textile according to claim 1, characterized in that:
A fuse is installed between terminal B of the slide rheostat of the adjustment resistor and the discharge electrode;
The fuse is a self-resetting fuse; If excessive current flows through it, the fuse will disconnect automatically; Once the temperature returns to ambient levels, the fuse will automatically reset, re-establishing the circuit.

5. The antistatic earthing textile according to claim 1, characterized in that:
A connecting portion is arranged on the cloth.

6. The antistatic earthing textile according to claim 5, characterized in that:
The connecting portion consists of a snap fastener, with the female snap positioned on the conductive yarn of the cloth and the male snap connected to the leading electrode of the electrostatic discharger.

7. The antistatic earthing textile according to claim 6, characterized in that:
The connecting portion is composed of conductive metal.

8. The antistatic earthing textile according to claim 1, characterized in that:
The intelligent load device comprises multiple singlechips, including a 1st, 2nd, and 3rd singlechip.

9. The antistatic earthing textile according to claim 8, characterized in that:
The connection method between the singlechips is pin-to-pin connection;
Wherein, the 2nd pin of the 1st singlechip is connected to the 1st pin of the 2nd singlechip; The 6th pin of the 1st singlechip is linked to terminal A of the slide potentiometer; The 7th pin of the 1st singlechip is parallel connected with the 7th pin of the 2nd singlechip, the 7th pin of the 3rd singlechip, and terminal B of the slide rheostat; The 8th pin of the 1st singlechip is connected to terminal A of the slide potentiometer, and the 5th pin of the 1st singlechip is connected to the 8th pin of the 2nd singlechip;
The 2nd pin of the 2nd singlechip is connected to the 1st pin of the 3rd singlechip, the 4th pin of the 2nd singlechip is connected to the 2nd pin of the 3rd singlechip, the 5th pin of the 2nd singlechip is connected to the 8th pin of the 3rd singlechip, and the 7th pin of the 2nd singlechip is connected to the 7th pin of the 3rd singlechip;
The 3rd pin of the 3rd singlechip is connected to the 4th pin of the 3rd singlechip, and the 5th pin of the 3rd singlechip is connected to terminal B of the slide rheostat.

10. The antistatic earthing textile according to claim 9, characterized in that:
The intelligent load device is provided with a plurality of resistors, including a 1st resistor, a 2nd resistor, a 3rd resistor, and a 4th resistor, wherein the 1st resistor is installed between terminal B of the slide rheostat and the intelligent load device, and the 2nd resistor, 3rd resistor, and 4th resistor are connected to the intelligent load device;
Wherein, the 1st resistor is connected in series between terminal B of the slide rheostat and the 5th pin of the 3rd singlechip, the 2nd resistor is connected in series between the 3rd and 4th pins of the 3rd singlechip, the 3rd resistor is installed between terminal A of the slide rheostat and the 8th pin of the 1st singlechip, and the 4th resistor is installed between terminal A of the slide rheostat and the 6th pin of the 1st singlechip.

11. The antistatic earthing textile according to claim 2, characterized in that:
The intelligent load device comprises multiple singlechips, including a 1st, 2nd, and 3rd singlechip.

12. The antistatic earthing textile according to claim 3, characterized in that:
The intelligent load device comprises multiple singlechips, including a 1st, 2nd, and 3rd singlechip.

13. The antistatic earthing textile according to claim 4, characterized in that:
The intelligent load device comprises multiple singlechips, including a 1st, 2nd, and 3rd singlechip.

14. The antistatic earthing textile according to claim 5, characterized in that:
The intelligent load device comprises multiple singlechips, including a 1st, 2nd, and 3rd singlechip.

15. The antistatic earthing textile according to claim 6, characterized in that:
The intelligent load device comprises multiple singlechips, including a 1st, 2nd, and 3rd singlechip.

16. The antistatic earthing textile according to claim 7, characterized in that:
The intelligent load device comprises multiple singlechips, including a 1st, 2nd, and 3rd singlechip.
